(19) United States
(12) Patent Application Publication
(10) Pub. No.: US 2003/0216817 A1
(43) Pub. Date: Nov. 20, 2003

(54) Vehicle access system with sensor

(76) Inventor: Richard Pudney, Plymouth, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/437,788

(22) Filed: May 14, 2003

Related U.S. Application Data
(60) Provisional application No. 60/380,992, filed on May 16, 2002.

(51) Int. Cl. G05B 11/01

(52) U.S. Cl. 700/17; 340/686.6; 340/541; 340/426.1; 340/5.72

(57) ABSTRACT

A system arrangement is disclosed. The system arrangement is comprised of a vehicle component, a sensor that senses a user's interaction with the vehicle component, and a controller operable to receive an input from the sensor in response to the user's interaction with the vehicle component and provide an output. Embodiments of the system also include a port and a port mechanism selectively operable in response to output to provide a function with respect to operation of the port, including the unlatching of the port.

### RELATED APPLICATIONS

This application claims right of priority from U.S. provisional patent application 60/380,992 filed on May 16, 2002, which is incorporated herein by reference in its entirety.

### TECHNICAL FIELD

The present invention relates generally to an acess system including a sensor. The system is suitable for use with a vehicle, such as, for example, identifying a request to unlatch or release a vehicle door or window.

### BACKGROUND

The prior art contains a number of designs for automatic door locking devices that can automatically lock or unlock vehicle doors with or without manual operation of a verification element, such as a key-fob. Generally, once unlocked, a user must manually actuate a conventional mechanical door handle to operate a latch mechanism that releases the door to be opened. Mechanical door handles, while used in vehicles for decades, may exhibit certain limitations. For example, mechanical door handles can “freeze-up” in cold climates rendering the handle unusable. Additionally, mechanical door handles typically include multiple moving parts that can fail during the life of the vehicle rendering the handle inoperable. Some mechanical door handles even exhibit pinch points or are otherwise cumbersome to operate for certain users. For these and other reasons, it is desirable to provide an improved vehicle system arrangement.

### SUMMARY OF THE INVENTION

An access system arrangement is disclosed. The system arrangement is comprised of a vehicle component, a sensor that senses a user's interaction with the vehicle component, and a controller operable to receive an input from the sensor in response to the user's interaction with the vehicle component and provide an output. Embodiments of the system also include a port and a port mechanism selectively operable in response to output to provide a function with respect to operation of the port, including the unlatching of the port.

### BRIEF DESCRIPTION OF THE DRAWINGS

FIG. 1 is a perspective view of an exemplary vehicle employing a system arrangement according to an embodiment of the present invention.

FIG. 2 is schematic of a side view of the vehicle of FIG. 1, showing a control circuit according to an embodiment of the present invention.

FIG. 3 is schematic of a side view of the vehicle of FIG. 1, showing a control circuit according to another embodiment of the present invention.

FIG. 4 is a cross-sectional view of a handle according to an embodiment of the invention.

FIG. 5 is a cross-sectional view of a handle according to another embodiment of the invention.

FIG. 6 is a cross-sectional view of a handle according to another embodiment of the invention.

FIG. 7 is a cross-sectional view of an emblem according to an embodiment of the invention.

FIG. 8 is a cross-sectional view of an emblem according to another embodiment of the invention.

FIG. 9 is a cross-sectional view of a handle according to another embodiment of the invention.

FIG. 10 is a cross-sectional view of a shift lever according to an embodiment of the invention.

### DETAILED DESCRIPTION

It is to be understood that the present invention may be embodied in other specific forms without departing from the scope of the invention. The illustrated and described embodiments are to be considered in all respects only as illustrative and not restrictive. The scope of the invention is, therefore, indicated by the appended claims rather than by the description. All changes that come within the meaning and range of equivalency of the claims and included elements are to be embraced within their scope.

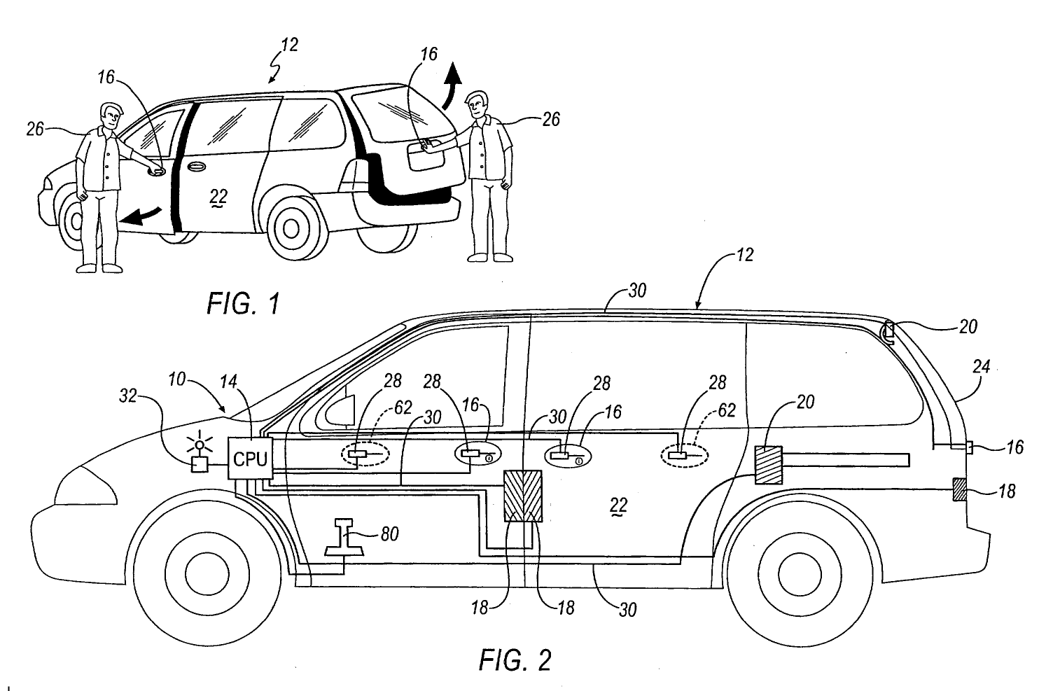

Referring now to FIGS. 1 and 2, an embodiment of the present invention is shown and described. The invention includes, among other things, a system arrangement 10 that is suitable for use in a vehicle 12 to facilitate opening or unlatching of various ports, including without limitation, vehicle doors, lift-gates, panels, or other points of access. System 10 can be used for example, without limitation, in connection with trunk latches, flip-glass latches and vehicle doors latches to release the corresponding component to be opened. Such latches may also include other types of vehicle entry/exit mechanisms, for example, those mechanisms associated with power sliding doors and/or lift gate doors.

In the embodiment shown in FIG. 2, system 10 includes a control circuit having a controller 14, (shown in FIG. 2 in the form of a central processing unit or CPU) and one or more handles 16 that facilitate opening of a vehicle panel. The term “vehicle component” as used herein is meant to describe a wide variety of parts or components, including, without limitation, handles or emblems, that are designed to be held, grasped, touched or otherwise interacted with by a user. In the illustrated embodiments of system 10, controller 14 can operate one or more functions, including latching/unlatching the vehicle doors, trunk lid and other ports to open or release the port to be accessed or opened. When so configured, each port includes a port mechanism, such as a latch mechanism 18, that is in operable connection with the port to effectuate opening of or access to the port in response to a controller output. Optionally, one or more of the vehicle doors, truck lid or other port may include an opening assist mechanism 20 (e.g., a leverage-based device or an automatic gas-assist mechanism) that opens or helps open the respective port with or without the assistance of a user.

In an embodiment, each latch mechanism 18 is an electronically or electrically-activated latch. Such a latch is known in the art and can be designed or set to unlatch when a signal from an associated system component is received. The associated system component may be a logic device (e.g., microchip within or otherwise in communication with the handle) or a controller for one or more functions, such as the controller identified as element 14. However, for the purpose of this application, all such associated system components may be referred to individually or collectively as a “controller.” Each latch 18 is selectively operable in response to a user request to unlatch a corresponding port to be opened under the user's power and/or under the power of opening assist mechanism 20. In the illustrative configuration shown in FIG. 2, a sliding side door 22 includes an opening assist mechanism 20, such as a motor driven mechanism, to slide side door 22 horizontally. Similarly, the rear door or lift-gate 24 includes an opening assist mechanism 20 to open lift-gate 24 vertically about a hinge. Opening assist mechanisms 20, such as those employed in vehicle 12 are also known in the art.

FIG. 1 shows a fairly generic representative vehicle 12 employing system 10 (such as in FIG. 2) in which a user 26 or a portion of the user (e.g., a hand) contacts or otherwise interacts (e.g., entering into a defined proximity range) with a handle feature or “handle” 16. A control unit 14 is in communication with the handle 16 and can respond to the user's interaction with handle 16 by operating the system 10 in a predetermined manner. For example, controller 14 may operate the front driver-side entry door latch mechanism 18 to release or unlatch the door to be opened in response to a user touching or grasping the door handle 16, for example, as shown in FIG. 1. In another example, controller 14 may operate the associated rear lift-gate latch mechanism 18 to release the lift-gate to be opened in response to the user touching a rear latch handle or other formation (e.g., an emblem), such as generally shown in FIG. 1.

In an embodiment, handle 16 includes a sensor 28 for “sensing” the user's interaction with handle 16 and communicates this interaction with controller 14. Among other things, the user's interaction with handle 16 can be interpreted by controller 14 as a request to operate latch mechanism 18 to unlatch a corresponding port and/or to activate opening assist mechanism 20- if so configured.

In an embodiment of the invention, controller 14 is provided in communication with one or more of the various components of system 10 (e.g. handle 16, latch mechanism 18 and opening assist mechanism 20) through one or more wires 30 or other physical connections. However, a suitable wireless communication interface may also be employed by the system 10 (either as an addition or substitution for “hard-wiring”) to provide a means for communication (e.g., input or signal) between a controller 14 with the various components of system 10. Alternatively, separate controllers may be placed into separate or individual communication with each component. System 10 may also include a wireless transmitter/receiver 32 in communication with controller 14, the use of which will be referred to in further detail below.

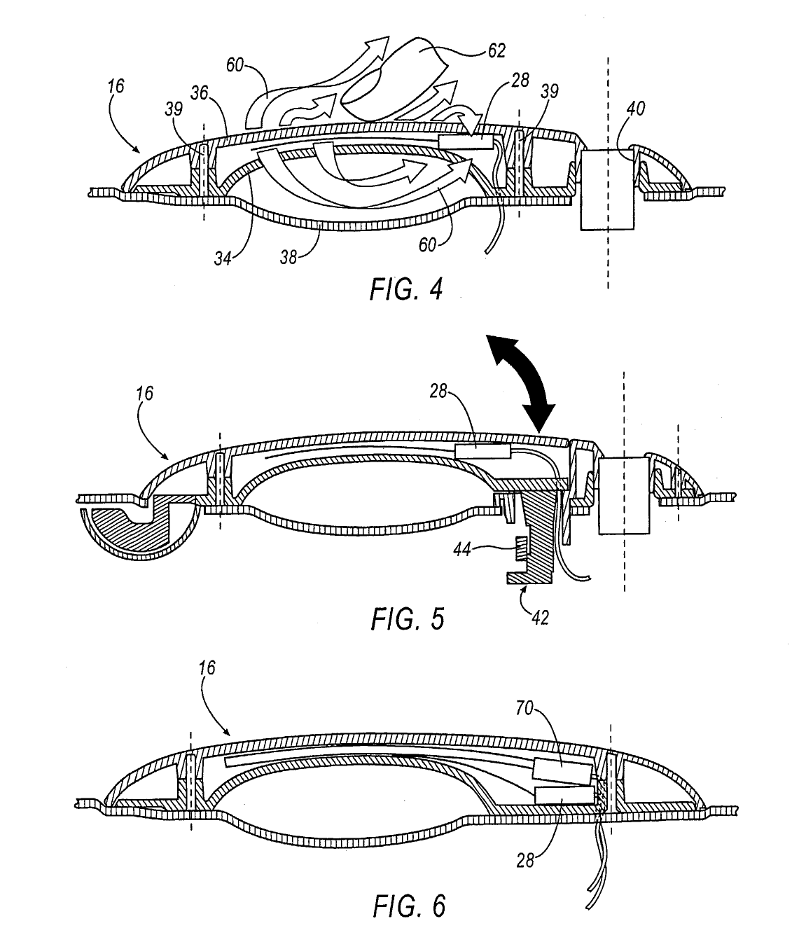

Referring to FIG. 4, an embodiment of a handle 16 is disclosed, in which the handle 16 is ridged and/or non-movably secured to vehicle 12 and does not require moving parts, such as hinges or mechanical levers. In an embodiment, the position and orientation of the handle remains substantially constant relative to a port and merely provides a rigid feature attached or affixed to a port to facilitate the opening of the port. In the illustrated embodiment, handle 16 includes, without limitation, three main components: a structural part 34, a decorative cover 36 and sensor 28. Sensor 28 can be positioned or packaged between structural part 34 and decorative cover 36, thus enclosing or “embedding” the sensor in the handle assembly. However, this is not the only way in which sensor 28 can be included for use in connection with handle 16 or the only structural design or configuration for the handle. If desired, sensor 28 can be insert molded into a one piece handle 16 or the structural component 34 could also be the decorative part and the cover 36 could be simply a cover to house the sensor on the non-visible surface of the handle (e.g., like a battery cover on a toy).

Handle 16 may also have other components, including, among other things, decorative gaskets or functional gaskets, which can serve to isolate handle 16 from the corresponding port 38 or other component of the vehicle. Handle 16 can also include a connector or connective material, such as some type of foam or tape to secure the sensor in place. There are a number of ways to secure handle pieces together: the parts may be snapped, glued, screwed, heat staked, welded or a combination of those or other conventional methods. For example, in an embodiment, a screw 39 or other fastener may be used to secure cover 36 to structural part 34 and/or handle 16 to the corresponding port. In another example, portions of two parts may be snapped or otherwise adhered together while using an expanding foam or liquid rubber/adhesive to provide a more robust feel and make dust proof and/or water resistant.

Handle 16 may also be configured to permit someone to snap or otherwise connect a cover 36 of the user's choice. For example, a user could connect a decorative cover 36 of their own selection and easily replace the same as they desire. As will also be appreciated, handle 16 can be manufactured in many colors and ornamental designs to complement the user's personal style or the vehicle decor.

Referring still to FIG. 4, if desired, a key cylinder (including conventional key cylinders) can be used in connection with the present concept to generally serve as a mechanical back-up for entry. In a particular embodiment, handle 16 can be designed to include a cooperative integral key cylinder housing 40, thus allowing the key cylinder to be packaged in the handle. Such an embodiment could effectively have the key cylinder packed or packaged into a handle 16. That option may be preferred in some applications because, among other things, the associated port component 38, such as the door sheet metal, would not need to be configured to house the key cylinder.

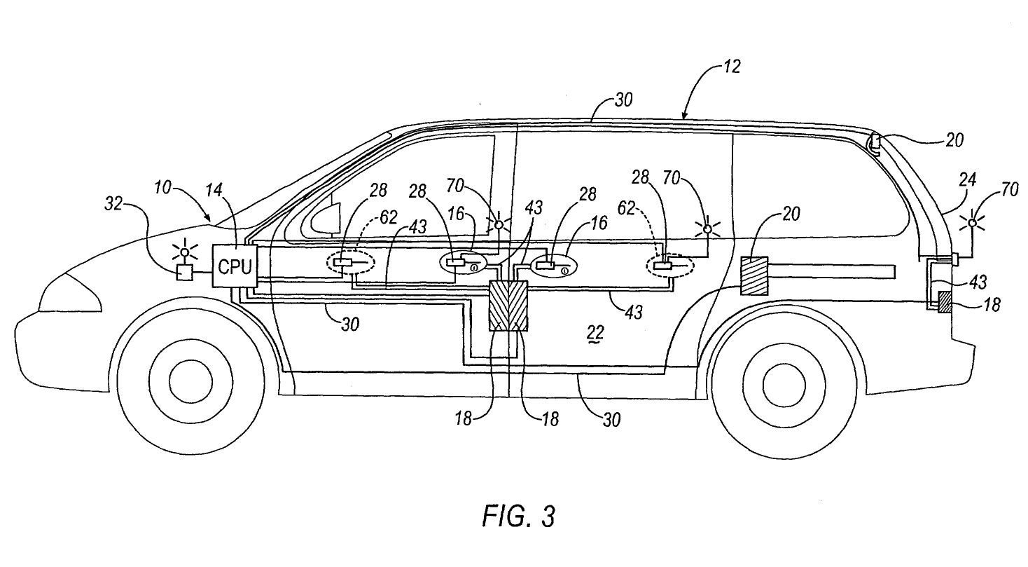

It is also possible to design handle 16 with some or all of the conventional mechanical components, with the intention that such components are available for use in the event that vehicle 12 loses power or the system otherwise fails to adequately perform as desired. In a representative embodiment, handle 16 includes a linkage member 42, represented generically in FIG. 5, which is mechanically connected or linked (the mechanical linkage represented generically as elements 43 in FIG. 3) to a mechanically/electrically activated door latch mechanism 18. The mechanical linkage member 42, or other component in the mechanically/electrically activated door latch mechanism 18, may be rendered selectively inoperable during normal operation of handle 16 and activated, if needed, to manually operate the corresponding door latch mechanism 18. For example, handle 16 may include a cam or cam-like component 44 that could stop the handle from moving when in normal operation, however, if power is lost, the operator could use a key to move the cam 44, thus allowing handle 16 to temporarily operate like any mechanical handle similar to those known in the art.

The handle 16 can also take on any number of different shapes, sizes and designs. It can be formed as a depression or bump in a door or access surface with a sensor packaged in or about the area where the handle would normally be placed to pull the door open. However, the invention is not so limited, and the handle can also be used in connection with a side door handle, sliding door handle, lift-gate handle, tailgate handle and/or can be packaged on a decorative badge or emblem such that the operator can simply touch the emblem and the associated door, trunk, or other access panel will open/unlatch.

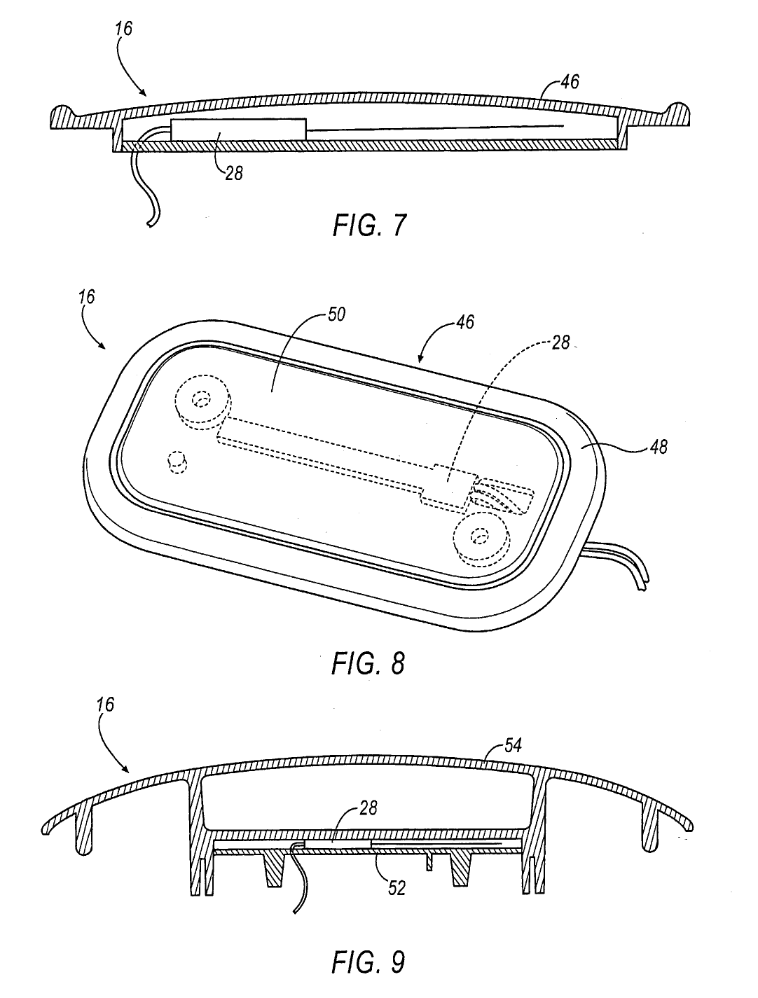

In one such embodiment shown in FIGS. 7 and 8, the handle 16 is packaged as a decorative emblem, such as a manufacturer's emblem or an emblem identifying the model of vehicle. In the illustrated embodiment, the emblem is not a handle that is gripped by the user to pull the corresponding port open, but rather a decorative feature that may display, for example, vehicle manufacturer or model information. In a particular illustrative configuration shown in FIG. 7, the emblem includes a generally flat structural housing 46 that generally surrounds or encapsulates sensor 28. If desired, sensor 28 can be insert molded into a one piece housing 46 or the emblem could be positioned between two or more components, such as a separate structural part 48 and a cover 50, as shown in FIG. 8. It will be appreciated that virtually any emblem on a vehicle can include and/or utilize such a sensor.

In addition to some of the applications for handles previously described, the sensor 28, it should be noted that a sensor 28 does not have to be packaged into the handle per se, such as a “pull-bar” (in whatever form the “pull-bar” may take for a given application). Further, if desired, the handle 16 can be designed with a housing or escushion/bezel with the sensor 28 positioned on the back side of the housing or embedded into the housing. In the embodiment illustrated in FIG. 9, handle 16 includes a sensor housing portion 52 and a pull-bar portion 54 that extends from the housing portion. Unlike the handles illustrated in FIGS. 4-6, the sensor 28 in handle 16 shown in FIG. 9 is contained in the housing portion 52 rather than the pull-bar portion 54. Some applications may require such a configuration because it would permit a handle to be more easily retrofitted onto current vehicles without requiring more costly investments, such as investment in manufacturing tooling to make an impression in a vehicle door panel.

The sensor 28 included in the various embodiments of handle 16 may be any conventional proximity sensor, such as a magnetic, capacitive, inductive, or acoustic sensor, which undergoes a change in electronic status in response to the presence of an object in an electric field. The sensor may be an off-the-shelf type sensor that can be adjusted or “tuned” as necessary or desired for specific applications. For instance, the sensitivity of the sensor can generally be modified or adjusted to meet a given user's preferences or an application's requirements. The sensor can also include a wire/connector or some type of contact point that communicates with controller 14. If desired, the sensor can also include additional electronic features to match the associated system, e.g., vehicle system requirements.

One form of sensor that may be used with the system is an electro-capacitive sensor, such as an electro-capacitive sensor marketed by Nippon Aleph. Among other features, electro-capacitive sensors offer a wide range of supply voltages (e.g., from about 5 to about 72 volts), operate at temperatures down to −40 degrees or lower, and operate on a relatively low standby current (less than 1 mA). Electro-capacitive sensors also exhibit a relatively fast response time (a max of about 100 msec), which enables the system to operate in a stand-by mode and selectively “switched-on” when needed. Electro-capacitive sensors may be generally shock and vibration resistant and operate through cloth and other materials (e.g., gloves). Electro-capacitive sensors are typically logic-ready or workable in the context of multiplex output. If desired, electro-capacitive sensors can be used in a system that will operate only when a hand approaches a door handle—for example, but without limitation, minimum contact area of 0.3 sq. in., which is approximately equal to the horizontal width of two adult fingers, with a detecting range distance of from about 0.1 to 1.2 inches. Because sensor 18 may be capacitive in nature, a circuit is closed (if power is supplied to it) when a user touches, approaches or otherwise interacts with handle 16. The output from sensor 18 may be hard wired, as shown in FIGS. 2 and 3, or may be provided to controller 14 wirelessly using a suitable wireless connectivity protocol.

Another sensor that may be used in connection with the system 10 is a field effect sensor, such as the TS-100 sensor marketed by Touchsensor Technologies LLC. Among other features, field effect sensors generally produce a relatively strong signal, have a relatively high immunity to electrical noise and contaminants, can work through various substrates, like plastic, glass and leather, and do not require software to operate. Unlike an electro-capacitive sensor, field effect sensors include a digital input/output at the point of touch, eliminating software (microprocessor) to interpret the analog signals found in electro-capacitive sensors. In operation, when a minimal voltage, e.g. 5 volts, is applied to a field effect sensor, an electric field 60 (represented generically in FIG. 4) is created around at least a portion of the sensor. The field emanates through any dielectric substrate, such as the handle material. When a conductive mass enters the field, the sensor detects the change and indicates an event has occurred. The input stimulus to the field can take many forms, including a human finger 62 or hand, for example.

Because sensor 28 may be integrated into or provided on an external vehicle component, such as an exterior door handle, external effects may lead to sensor 28 operating unintentionally, for example by the influence of rain, snow and ice. To prevent unintentional operation, controller 14 and/or sensor 28 may be configured to “switch” only when a change in a property of the sensor field is greater than a predetermined threshold value, or the rate of change in a property of the sensor field exceeds a threshold value.

In another embodiment, system 10 can be configured to limit the power application to a specific time to better protect the electronically activated components from damage. In a particular configuration, controller 14 senses or knows when the electronically activated latch mechanism 18 is in the open position so that the door closes when a user's hand is on or in a predetermined proximity of handle 16. For example, if a user is holding the door open for someone and then closes the door, all the while holding onto handle 16, controller 14 can be designed to know or recognize that the subject door is unlatched and there is no need for the controller to supply power to the latch mechanism 18 that is already open. In addition, when a user closes a door, the user would not typically want the latch mechanism 18 to stop the user from closing the door. The system 10 can be designed to prevent such an occurrence. Such optional types of customization can permit the system 10 to work in a wide range of fields and applications, e.g., across a number of different vehicle platforms. To achieve such flexibility is only a matter of general vehicle electronics (e.g., the present invention can make use of electronics associated with the “door ajar” signal already in a vehicle system to tell the controller to stop sending power to the electronically activated latch mechanism 18 and/or sensor 28. It should also be noted that, if desired, system 10 can be designed so that a user does not need to physically touch handle 16. In short, in some embodiments the sensor 28 can be adjusted or tuned to function as a proximity sensor.

In another embodiment, the function of a traditional lock/unlock device can be replaced by system 10. In such circumstances, the lock/unlock device is not required because when a vehicle is locked, the controller 14 does not supply power to sensor 28, thus making it inactive and thereby “locking” the door. Further, in such circumstances, there would be no “thunk” or other mechanical noise when the lock button is depressed because there would not be any associated moving pieces on the vehicle for lock and unlock. If the lack of such noises poses a concern to a user (e.g., not knowing if the button actually worked), this can be addressed by other audio or visual signals, such as having the horn sound or the lights blink on and off. It is also possible to have the vehicle display a lock/unlock light on the dashboard or even provide a recorded voice acknowledging that the user has indeed locked or unlocked the door or panel.

In some vehicle applications, when a vehicle is put in drive or reaches a minimum speed, controller 14 can be programmed or set to shut power off to sensor 28, effectively automatically locking a door when the vehicle is in operation. Such a feature would be somewhat similar in operational results to conventional systems in the market; however, the present invention does not require all of the moving parts that a conventional system needs to accomplish a similar function. To account for conditions of power failure, the vehicle can be equipped with one or more mechanical override systems. In some circumstances, it may be desirable to utilize existing technology similar to that conventionally used with trunk lids. For instance, without limitation, a user could mechanically override the system by inserting a key into a corresponding key cylinder and may be required to turn the key. The entry or turning of the key could trip the corresponding latch and, depending upon whether it is desired, unlock the door. Some embodiments may use a cable system to transfer the motion of the key to the lever on the latch. However, this can also be achieved with a rod, which may reduce cost. There are several other ways to include conventional technology to mechanically override system 10. For example, a more traditional door handle/latch opening mechanism (e.g., FIG. 3) may be used in conjunction with the handle embodiment illustrated in FIG. 5.

Additionally, if desired, the vehicle could be packaged with or otherwise include a release lever/handle in the trunk. The lever/handle could include a sensor 28 that would sense interaction by a user trapped in the truck to release the truck latching mechanism. Such a device may include a light or exhibit glow-in-the-dark characteristics to allow a person trapped in the trunk to find the release lever/handle.

Optionally, a simple cable could be attached to the rear door latch with an inexpensive handle attached to the end in the trunk. If power is lost, the user can open the trunk lid with the user's key and touch or pull the “handle,” thereby releasing the latch on the rear door and giving the user access to the inside of the vehicle. Such an embodiment could eliminate the desire or need for key cylinders on the side doors and serve to further reduce associated costs while improving vehicle security. The invention permits the inclusion of hardware for a user to insert a key into a lockset (entry or turning can be required). Such features can include and exploit known technologies (such as those included in domestic vehicle trunk lids).

In another application, inside vehicle handles 62 (such as those in the interior of a vehicle in FIGS. 2 and 3) may be configured like handles 16 to include a sensor 28 or could be replaced with a sensor 28 positioned or packaged in an inner door panel or any other convenient place. An operator could touch or otherwise interact with the handle 62, sensor 28 or sensor area and the associated door would unlatch. In some instances, such as where standards (e.g., FMVSS) require, a mechanical way to open the vehicle from the inside can be included, however, the inside handle could be a very inexpensive device, such as a one-finger handle that's only anticipated use is in connection with power failures. A more traditional door handle/latch opening mechanism may also be equipped with the inside door handles 62 that include sensor 28.

Sensors 28 can be included or placed in two or more handles (or other convenient vehicle component) to provide a key-less/key “fob-less”-entry into a door, compartment, or other port, for example, such as those used in connection with certain domestic vehicle button pads. Such a system could eliminate the need for moving components and the associated sensors 28 could, if desired, be positioned or embedded in a handle or emblem. For example, in the embodiment illustrated in FIGS. 1 and 2, system 10 could be configured to allow user 26 to unlock the vehicle 12 by touching, or otherwise interacting with, a front door handle twice and then touching a side door handle once. However, any timing or sequence pattern could be programmed into controller 14 to authorize a specific function concerning entry into or use of the vehicle. Such a system could also be used to operate other vehicle functions, such as, for example, locking the vehicle or lowering one or all of the vehicle windows.

Pursuant to the above described embodiments, there are a number of applications that can be contemplated in connection with the invention. Such applications, which may use all or some of the components of this invention, include, without limitation, use with sliding doors and/or lift gates, including those with automatic doors. If desired, the system could be designed so that there is no need for a pull handle, e.g., the door could include a sensor positioned or packaged at virtually any convenient (or inconvenient) location. An operator could simply touch the sensor area and the door would unlatch and open.

Including such a sensor in handles 16, such as those used on a vehicle to open a port, such as the vehicle cabin and/or trunk, can provide a number of benefits including, without limitation, a reduction in the number of moving parts in a vehicle door, the elimination of pinch points in (e.g., between a handle hinge) and/or improved sealability (the handles 16 of the invention can be sealed at the attachment points to be essentially airtight and watertight). The handles 16 of the present invention may also reduce or eliminate noises (such as wind noise) from entering the vehicle. Because the handles 16 can be non-movably secured to the vehicle, the handles provide a more robust feel without the squeaks and or rattles associated with more traditional movable vehicle handles. This feature can also eliminates various conventional door handle components, including without limitation, rivets, bumpers, springs, bellcranks, rodclips, counterbalances, gaskets, sleeves, keycaps, pivot brackets, and grease, which may result in a weight reduction and cost savings.

System 10 may, if desired, be designed to function with “active” and “passive” entry features. When a vehicle (such as vehicle 12) is equipped with “active entry” features, an additional act is required on the user's part before unlatching occurs (so that the mere presence of the driver is not enough to unlatch the doors). In a representative embodiment, system 10 permits a user 26 to unlock the vehicle by pressing a button on a conventional “active entry” type key fob. The ports remain latched, but are unlatched when the user signals an intention to open a port, such as by touching or otherwise interacting with a handle 16, which includes sensor 28 contained therein that activates the unlatching mechanism 18 associated with the corresponding port. Following unlatching, the user is able to pull on the handle 16 to open the port in a conventional manner, or pull on the port itself when the handle 16 does not include a pull bar (e.g. when the handle 16 is an emblem).

“Authorization” for entry into the vehicle may be based upon the signal from the key fob or other form of signal/confirmation. For example, pressing a button on the fob may effectively “unlock” the door (as opposed to “unlatching” the door, which is subsequently accomplished by interacting with handle 16 and activating sensor 28). The controller 14 will allow power to reach the corresponding electronically activated latch mechanism 18 if sensor 28 is “on” and is activated by the user. To save battery power, system 10 may be configured to automatically power down during periods of nonuse. However, because of the relatively low drain of power from the electrical system associated with the operation of the sensors (as low or lower than 15 microamps), the controller 14 may provide power to the sensor 28 all of the time and controller 14 will send power to unlatch the port or not depending on whether or not the car is locked or unlocked (e.g., as controlled by the key fob). Alternatively, controller 14 can be configured to send power to sensor 28 only when the car is unlocked and the power could be shut off when the car is locked.

The system may, if desired, also include passive entry features. When a vehicle (such as vehicle 12) is equipped with “passive entry” features, the user 26 can simply walk up to vehicle 12 and the system 10 will turn on automatically. In an embodiment of the invention shown in FIGS. 3 and 6, a transmitter/receiver antenna 70 is positioned within or embedded in handle 16 along with sensor 28. When activated, antenna 70 sends out a signal looking for an associated response (presumably from a permitted user device, such as an electronic key). Providing an antenna 70 in the handle allows a relatively low power signal to be issued by system 10, thus saving battery power. Alternatively wireless transmitter/receiver 32 may be used alone or in combination with antenna 70 to provide a separate, possibly stronger signal, to extend the reach of the inquiry zone.

In one configuration, when the device or “key” is detected, system 10 is activated and power is supplied to sensor 28. When the user touches (or otherwise activates) handle 16, the sensor 28 senses the user (e.g. the user's hand) and effectively “unlocks” the vehicle, such as by permitting use of latch mechanisms 18. The user then pulls on the handle and mechanically triggers the door latch.

In another configuration, when the device or “key” is detected, the system 10 is activated and power is supplied to sensor 28. When the user touches (or otherwise activates) handle 16, the sensor 28 senses the user and unlatches the corresponding port. As noted above, a mechanical override system can be included in case of vehicle power failure. Also, if desired, the “key” (Fob) and the lock/unlock button could always permit a user to override system 10.

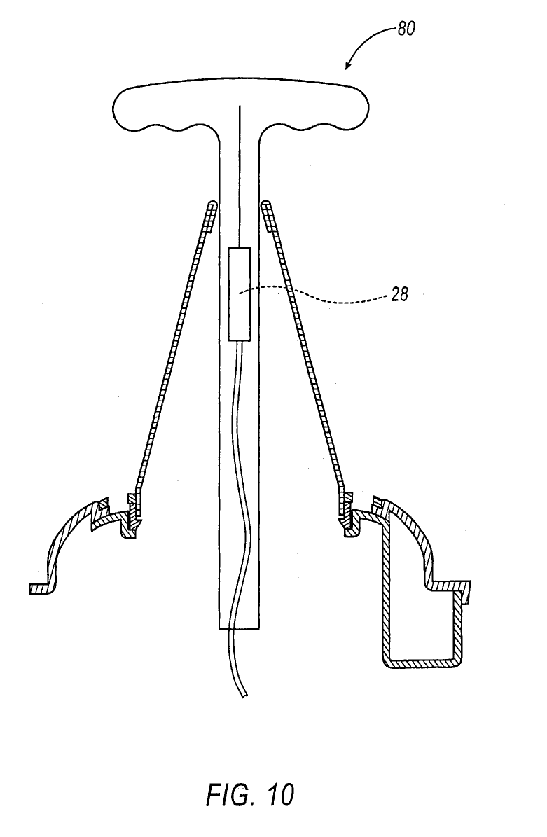

Another embodiment of the invention in connection with other vehicle control devices is shown in FIGS. 2 and 10. In this embodiment, a vehicle shift lever 80 is provided (represented generically in FIGS. 1 and 10) that includes a sensor 28, such as the sensors described above and used in handle 16. Unlike mechanically operated shift levers that require a user to manually actuated a button to release the shift lever from “park” and move the lever to another position, such as “reverse” or “drive,” shift lever 80 is electronically released for movement. When permitted by the system 10, a user's touch, approach or interaction with shift lever 80 is sensed by sensor 28 and communicated to controller 14, which releases shift lever 80 for movement in a conventional manner. Like known shift lever designs that inhibit movement of the shift lever during certain predetermined vehicle operating conditions, controller 14 can be configured to prohibit use of shift lever 80 under similar operating conditions. For example, controller 14 may be programmed to shut power off to sensor 28 unless the user is operating the vehicle brakes, such as when shift lever is in “park” and the vehicle is not moving. As will be appreciated, sensor 28 replaces the multiple moving parts found in conventional shift levers, which can be rendered inoperable due to contaminants, such as dirt and other debris.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A system comprising:
a vehicle component;
a sensor that senses a user's interaction with the vehicle component;
a controller that receives an input from the sensor associated with the user's interaction with the vehicle component and provides an output;
a port; and
a port mechanism that is selectively operable in response to the output to provide a function with respect to operation of the port; wherein the function includes the latching or unlatching of the port.

2. The system of claim 1, wherein the vehicle component includes a handle.

3. The system of claim 2, wherein the handle does not include any moving parts.

4. The system of claim 1, wherein the port includes a door, window, lift gate, or other access opening of a vehicle.

5. The system of claim 1, wherein the port mechanism includes a latch mechanism.

6. The system of claim 1, wherein the port mechanism includes an opening assist mechanism that is selectively operable in response to the output.

7. The system of claim 1, wherein the sensor is supplied with power when the port is in a closed configuration.

8. The system of claim 1, wherein the sensor is without power until after the controller receives an authorization.

9. The system of claim 8, wherein the port mechanism is without power when the sensor is without power.

10. The system of claim 2, wherein the sensor is substantially embedded or enclosed within the handle.

11. The system of claim 2, wherein the handle includes a structural part and a cover.

12. The sensor of claim 11, wherein the sensor is positioned between the structural part and the cover.

13. The system of claim 11, wherein the structural part is integrally formed with the cover.

14. The system of claim 2, wherein the handle includes a key cylinder housing.

15. The system of claim 2, wherein the door handle includes a mechanical component to facilitate mechanical operation of the port mechanism.

16. The system of claim 2, wherein door handle includes a housing portion and a pull-bar portion, the sensor positioned substantially in the housing portion.

17. The system of claim 2, wherein the handle is an interior handle.

18. The system of claim 1, wherein the vehicle component includes an antenna.

19. The system of claim 1, wherein the vehicle component includes an emblem.

20. The system of claim 19, wherein the emblem includes identifying information.

21. The system of claim 1, wherein the sensor comprises a proximity sensor.

22. The system of claim 1, wherein the sensor comprises an electro-capacitive sensor.

23. The system of claim 1, wherein the sensor comprises a field effect sensor.

24. The system of claim 1, wherein the output is selectively communicated to the port mechanism in response to a predetermined vehicle condition.

25. The system of claim 1, wherein the vehicle is locked by rendering the sensor inoperable and unlocked by rendering the sensor operable.

26. The system of claim 1, wherein when the vehicle achieves a predetermined operating condition, the sensor is rendered inoperable.

27. The system of claim 1, wherein one or more vehicle components include sensors that are cooperatively interacted with in a predetermined timing or sequence pattern to generate the output.

28. The system of claim 1, wherein the system is configured for receiving an active entry identification.

29. The system of claim 28, wherein a key fob provides an active entry signal to the system.

30. The system of claim 1, wherein the system is configured for receiving a passive entry identification.

31. The system of claim 1, wherein the controller includes a logic device or a processor.

32. The system of claim 31, wherein the controller includes a microchip.

33. The system of claim 1, wherein the controller is positioned substantially within the handle.

34. The system of claim 1, wherein the controller is included as a part of a central processing unit for a vehicle.

35. A system comprising:
a vehicle component;
a means for sensing a user's interaction with the vehicle component;
a means for receiving an input from the means for sensing and providing an output;
a port; and
a means for unlatching or latching the port.

36. A component for use in a vehicle to facilitate opening of a port, comprising:
a protective housing that is rigidly secured to the port; and
a sensor positioned within the housing;
wherein the position of the housing remains unchanged relative to the port and the sensor senses a user's interaction with the housing and provides an output to authorize opening of the port.

37. The component of claim 36, wherein the protective housing comprises a handle.

38. The vehicle component of claim 36, wherein the protective housing comprises an emblem.

39. A handle for use in a vehicle to authorize a mechanism to unlatch a port, comprising:
a structural part;
a cover; and
a sensor positioned substantially between the structural part and the cover; the sensor operable to sense a user's interaction with the handle and to authorize operation of the mechanism to unlatch a port.

40. The handle of claim 39, wherein the structural part and cover are integrally formed.

41. The handle of claim 39, wherein the handle does not include any moving parts.

42. The handle of claim 39, wherein the port includes a door and the handle is rigidly and non-movably secured to the door.

43. The handle of claim 39, wherein the port includes a door and at least one of the structural part and cover are integrally formed with the door.

44. The handle of claim 39, wherein the handle includes an antenna.

45. The handle of claim 39, wherein the handle includes a key cylinder housing.

46. The handle of claim 39, wherein the handle includes a mechanical component to facilitate mechanical operation of the mechanism.

47. The handle of claim 39, wherein handle includes a housing portion and a pull-bar portion, the sensor positioned in the housing portion.

48. An emblem for use in a vehicle to authorize a mechanism to unlatch a port, comprising:
a protective housing; and
a sensor positioned within the protective housing; the sensor operable to sense a user's interaction with the housing and to authorize operation of the mechanism to unlatch a port.

49. The emblem of claim 48, wherein the emblem includes identification information.

50. The emblem of claim 48, wherein the protective housing is integrally formed with a component of the vehicle.

51. The emblem of claim 48, wherein the port is a door and at least a portion of the protective housing is integrally formed with the door.

52. The emblem of claim 48, wherein the protective housing includes a structural part and a cover.

53. A vehicle control device comprising:
a sensor that senses a user's interaction with the vehicle control device, the vehicle control device being substantially located within the vehicle;
a controller that receives an input from the sensor associated with the user's interaction with the vehicle control device, evaluates a present condition associated with the vehicle; and, if the evaluation of the condition meets a predefined criteria, permits the mechanical operation of the vehicle control device.

54. The device of claim 53, wherein the vehicle control device is a movable component, lever, or shifter.

55. A method for latching or unlatching a port comprising:
providing a vehicle component, a sensor that senses a user's interaction with the vehicle component, a controller that receives an input from the sensor and provides an output, and a port mechanism for latching or unlatching the port;
providing power to the controller;
sensing the user's interaction with the vehicle component;
providing a signal to the controller that the user has interacted with the vehicle component;
sending an output from the controller to the port mechanism; and
activating the port mechanism to latch or unlatch the port.

56. A method as recited in claim 55, wherein the controller is powered in response to an active signal received from the user.

57. A method as recited in claim 56, wherein the active signal is produced by a key fob.
